(19) United States
(12) Patent Application Publication
(10) Pub. No.: US 2017/0066193 A1
(43) Pub. Date: Mar. 9, 2017

(54) 3D MULTIFUNCTIONAL DEVICE WITH 3D SCANNING FUNCTION AND 3D PRINTING FUNCTION AND OPERATION METHOD THEREOF

(71) Applicant: ELECTRONICS AND TELECOMMUNICATIONS RESEARCH INSTITUTE, Daejeon (KR)

(72) Inventors: Jae-Hean KIM, Sejong (KR); Hyun KANG, Daejeon (KR); Jung-Jae YU, Daejeon (KR); Hye-Sun KIM, Daejeon (KR); Chang-Joon PARK, Daejeon (KR); Yun-Ji BAN, Daejeon (KR); Dong-Wan RYOO, Daejeon (KR); Jin-Sung CHOI, Daejeon (KR)

(21) Appl. No.: 15/072,545

(22) Filed: Mar. 17, 2016

(30) Foreign Application Priority Data
Sep. 4, 2015 (KR) 10-2015-0125753

(51) Int. Cl. B29C 67/00; B33Y 30/00; B33Y 50/00; B33Y 10/00

(52) U.S. Cl. CPC B29C 67/0088; B29C 67/0085; B29C 67/0059; B33Y 10/00; B33Y 30/00; B33Y 50/00

(57) ABSTRACT

A 3D multifunctional device in which a 3D printer and a 3D scanner are combined and a method for operating the device. The 3D multifunctional device includes a printing unit that includes a nozzle for ejecting material for 3D printing, a scanning unit that includes a light radiation module for radiating light to an object to be scanned and a camera for capturing an image of the object, a head unit for moving the printing unit and the scanning unit in X-axis and Y-axis directions, a bed plate on which the object to be scanned is located or the ejected material is deposited, the bed plate moving in a Z-axis direction, and a control unit for setting a function by selecting 3D scanning or 3D printing, controlling the scanning unit or the printing unit, and controlling the movements of the head unit and bed plate.

### CROSS REFERENCE TO RELATED APPLICATION

This application claims the benefit of Korean Patent Application No. 10-2015-0125753, filed Sep. 4, 2015, which is hereby incorporated by reference in its entirety into this application.

### BACKGROUND OF THE INVENTION

1. Technical Field

The present invention relates generally to a 3D multifunctional device and a method for operating the device, and more particularly, to a 3D multifunctional device that has a 3D scanning function and a 3D printing function.

2. Description of the Related Art

3D printing technology is a series of techniques that are necessary in order to create a real-world object having a physical form from a digital model produced in 3D, and 3D scanning technology is a series of techniques for acquiring information about the shape of an object to be scanned by radiating laser light, modulated light, or structured light thereto, and for converting the acquired information about the shape into digital information.

3D printing has been mainly used in order to manufacture prototypes of products, but the field of application thereof has broadened thanks to technical improvements, increased economic feasibility, and the like. Also, with the dissemination of 3D printers, 3D printing is expanding to application fields aimed at general users. Specifically, 3D printing is applied to various industrial fields such as consumer goods, electronics, automotives, medical and dental industries, industrial machines, office machines, aerospace, and the like, and is mainly used for manufacturing functional components. Also, recently, as it is used for producing prostheses, artificial organs, and the like in the medical field, the development of related technology and the expansion of the market are expected.

Meanwhile, 3D scanning technology, which is developing along with 3D printing technology, may acquire the size, shape, color, and depth information of an object to be scanned and produce 3D data of the type required for 3D printing. The 3D scanning technology may comprise software for analyzing and processing data and hardware that includes a light radiation unit, a light reception unit, a communication device, a display, and the like. In the 3D scanning technology, a technique for preventing parts of an object to be scanned from being missed is very important.

Recently, as 3D scanning and 3D printing are extensively used, a product in which a 3D scanner and a 3D printer are combined has emerged, but this product has a structure in which the 3D scanner is simply disposed inside the 3D printer.

Therefore, there is urgently required for technology pertaining to a new 3D multifunctional device that may improve the efficiency of 3D scanning or 3D printing by taking structural advantages of a 3D scanner or a 3D printer.

In connection with this, Korean Patent Application Publication No 10-2015-0090594, discloses a technology on Aug. 6, 2015 related to “3D printer having 3D scanner”.

### SUMMARY OF THE INVENTION

An object of the present invention is to provide a 3D multifunctional device that is capable of both 3D printing and 3D scanning without requiring an additional module to be installed in a 3D printer, or using the minimum number of modules.

Another object of the present invention is to minimize the areas that are missed when 3D scanning is performed.

A further object of the present invention is to implement a scanning unit for 3D scanning as a detachable unit, whereby the scanning unit can be mounted on a 3D multifunctional device when a user needs it.

In order to accomplish the above objects, a 3D multifunctional device according to the present invention includes a printing unit that includes a nozzle for ejecting a material for 3D printing of an object; a scanning unit that includes a light radiation module for radiating light to an object to be scanned and a camera for capturing an image of the object to be scanned; a head unit for moving the printing unit and the scanning unit in X-axis and Y-axis directions; a bed plate on which the object to be scanned is located or the material ejected from the nozzle is deposited, the bed plate moving in a Z-axis direction; and a control unit for setting a function to be used by selecting either a 3D scanning function or a 3D printing function, for controlling the scanning unit or the printing unit to correspond to the set function, and for controlling movements of the head unit and the bed plate, wherein the printing unit and the scanning unit are connected to each other through the head unit.

The printing unit or the scanning unit may be detachable from the head unit.

The head unit may include the light radiation module and the camera, located on respective opposite sides of the nozzle.

The light radiation module may radiate linear light to the object to be scanned in a Y-axis direction.

The light radiation module may radiate any one of laser light, modulated light, and structured light.

The bed plate may have a form of a rotatable turntable.

If the 3D scanning function is set to operate, the control unit may rotate the bed plate and move the head unit to make the light radiation module and the camera scan the object to be scanned in 3D.

The head unit includes a rotation module that is rotatable with respect to any one axis, and the rotation module may rotate at least one of the nozzle, the light radiation module, and the camera.

The control unit may detect an area missed during scanning of the object to be scanned and makes the scanning unit scan the missed area again by moving the head unit and the bed plate when the missed area occurs.

Also, a method for operating a 3D multifunctional device according to an embodiment of the present invention includes setting a function to be used by selecting either a 3D scanning function or a 3D printing function; moving a head unit in X-axis and Y-axis directions or moving a bed plate in a Z-axis direction, to correspond to the set function; if the 3D scanning function is set, radiating light to an object to be scanned, which is located on the bed plate, and capturing an image of the object to be scanned, and if the 3D printing function is set, ejecting a material for 3D printing an object on the bed plate, wherein the head unit includes a light radiation module for radiating the light, a camera for capturing the image of the object to be scanned, and a nozzle for ejecting the material.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating the configuration of a 3D multifunctional device according to an embodiment of the present invention;

FIG. 2 is a flowchart illustrating a method for operating a 3D multifunctional device according to an embodiment of the present invention,

FIG. 3 is a view illustrating the structure of a 3D multifunctional device according to a first embodiment of the present invention,

FIG. 4 is a view illustrating the structure of a 3D multifunctional device according to a second embodiment of the present invention;

FIG. 5 is a view illustrating the structure of a head unit according to a first embodiment of the present invention; and

FIG. 6 is a view illustrating the structure of a head unit according to a second embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a preferred embodiment of the present invention will be described in detail with reference to the accompanying drawings.

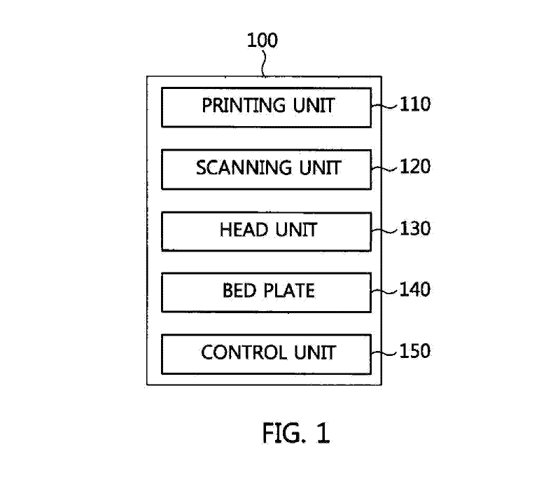

FIG. 1 is a block diagram illustrating the configuration of a 3D multifunctional device according to an embodiment of the present invention.

Referring to FIG. 1, a 3D multifunctional device 100 includes a printing unit 110, a scanning unit 120, a head unit 130, a bed plate 140, and a control unit 150.

First, the printing unit 110 functions as a 3D printer and includes a nozzle that ejects material for 3D printing. The printing unit 110 is mounted on the head unit 130, which can move along an X-axis and a Y-axis, and moves along with the movement of the head unit 130.

The printing unit 110 of the 3D multifunctional device 100 is for printing a 3D object corresponding to input 3D data, and may be a 3D printer that uses Fused Deposition Modeling (FDM), in which material in a wire form is extruded through an extrusion nozzle head.

Alternatively, the printing unit 110 may be a 3D printer that uses Stereo Lithography Apparatus (SLA) or Digital Light Processing (DLP), which solidifies liquid photo-reactive resin using a laser beam or a strong UV light, or a 3D printer that uses Selective Laser Sintering (SLS), which sinters powdered material using a laser beam under a high temperature and a high pressure.

The printing unit 110 may be implemented as at least one of a 3D printer that uses Color Jet Printing (CJP), which sprays a liquid binder to material through a printer head nozzle, a 3D printer that uses Poly Jet and Multi Jet Printing (MJP), which is a combination of inkjet and photo curing that solidifies material while being sprayed from a printer head, and a 3D printer that uses PLT, PSL, and LOM, which cuts sheet-type material using a precise cutter and applies heat thereto to join it.

In particular, if the printing unit 110 is a printer that uses FDM, the printing unit 110 may further include an extruder and a cooling fan. First, the extruder pushes material into a nozzle using a motor and applies heat thereto to melt it. Then, the nozzle, arranged in front of the extruder, outputs the melted material in the desired size. Also, the cooling fan, which quickly cools the melted material when it is output, may be installed in front of the nozzle in order to prevent the melted material from contracting.

Next, the scanning unit 120 functions as a 3D scanner and includes a light radiation module for radiating light to an object 200 to be scanned and a camera for capturing an image of the object 200 to be scanned.

The light radiation module of the scanning unit 120 may radiate any one of laser light, modulated light, and structured light to the object 200 to be scanned. If the object 200 to be scanned is a black material or if it strongly reflects light, 3D scanning can be performed using a laser line. Also, in order to improve the precision of 3D scanning, the scanning unit 120 may perform 3D scanning using modulated light or structured light from a halogen light or LED.

If the scanning unit 120 is an optical triangulation laser scanner, the light radiation module radiates point-type or line-type laser light to the object 200 to be scanned, and the camera may receive reflected light. At this time, because the scanning unit 120 is already aware of the distance and angle between the camera and the light radiation module, it may perform 3D scanning using the difference between the depths of the received light within the view angle of the camera depending on the relative location of the camera.

Also, if the scanning unit 120 is a modulated-light 3D scanner, 3D scanning may be performed in such a way that light having a variable frequency is continually radiated to the surface of the object 200 to be scanned and a distance is acquired by detecting the difference in frequencies when the camera receives the light.

Also, if the scanning unit 120 is a structured-light 3D scanner, 3D scanning may be performed in such a way that the scanning unit 120 projects a specific pattern of light, such as light having a linear pattern, onto the object 200 to be scanned and detects the deformation of the pattern.

The head unit 130 may be physically connected to the printing unit 110 and the scanning unit 120, and may move the printing unit 110 and the scanning unit 120 along an X-axis and a Y-axis.

At least one of the printing unit 110 and the scanning unit 120 may be implemented as being detachable from the head unit 130. A user may mount the printing unit 110 or the scanning unit 120 on the head unit 130 of the 3D multifunctional device 100 when necessary, so that the 3D multifunctional device 100 may perform 3D printing or 3D scanning.

Also, the nozzle of the printing unit 110 is located at the center of the head unit 130, and the laser and camera of the scanning unit 120 may be respectively located on the left and right sides of the nozzle.

For the convenience of description, the head unit 130 is described as being separable from the printing unit 110. However without limitation to this, the 3D multifunctional device may have a structure in which the printing unit 110 and the head unit 130 are combined into a single module. In this case, the scanning unit 120 may be physically connected to the printing unit 110, and the scanning unit 120 may operate in order to correspond to the movement of the printing unit 110.

Also, the bed plate 140, on which the object 200 to be scanned is located when the 3D multifunctional device 100 performs 3D scanning, is in the form of a rotatable turntable, and rotates the object 200 to be scanned to enable the scanning unit 120 to scan the object 200 to be scanned in all directions.

Also, when the 3D multifunctional device 100 performs 3D printing, a 3D object, printed out by depositing material ejected from the nozzle, is settled on the bed plate 140. In this case, the bed plate 140 may be made of material that can easily adhere to the 3D object, which is the result of 3D printing. Also, if the printing unit 110 is a 3D printer that uses ABS material, the bed plate 140 may include a heat plate for raising a temperature when performing 3D printing in order to prevent the printed result from contracting in response to thermal change.

The control unit 150 sets a function to be used by selecting either a 3D scanning function or a 3D printing function, and controls the printing unit 110 or the scanning unit 120 to correspond to the set function.

The control unit 150 sets the function whereby a user selects the function to be used from among the 3D scanning function and the 3D printing function, or may automatically set the function by recognizing whether an object to be scanned is located on the bed plate 140. Then, the control unit 150 may control the printing unit 110 or the scanning unit 120 to correspond to the set function.

Also, the control unit 150 controls the movement and rotation of the head unit 130 and bed plate 140 when 3D printing or 3D scanning is performed.

When the 3D multifunctional device 100 performs 3D printing, the control unit 150 activates the printing unit 110, receives 3D data describing the object to be created by 3D printing, and controls the printing unit 110 to perform processes of pushing material into the nozzle, applying heat thereto, and outputting the material, having been melted in the nozzle.

Also, the control unit 150 makes the printing unit 110, which includes the nozzle, move along the X-axis and Y-axis, whereby the nozzle may spray the material so as to correspond to the 3D data for 3D printing. Also, when the printing unit 110 completes one layer by spraying the material, the control unit 150 makes the bed plate 140, on which the material is deposited, move along the Z-axis. Also, if the head unit 130 is movable in the Z-axis direction, the control unit 150 may control the head unit 130 so as to move it in the Z-axis direction.

For the convenience of a description, the head unit 130 is described as moving in the X-axis and Y-axis directions. However, without limitation to this the printing unit 110 and the scanning unit 120, which move to correspond to the head unit 130 and the movement thereof, may move in at least one direction selected from among the X-axis, Y-axis, and Z-axis directions.

Meanwhile, when the 3D multifunctional device 100 performs 3D scanning, the control unit 150 activates the scanning unit 120, radiates light to the object 200 to be scanned, and controls the scanning unit 120 in order to capture an image of the reflected light. In this case, the control unit 150 may make the bed plate 140 rotate and control the movement of the head unit 130 in order to emit the light to all parts of the object 200 to be scanned.

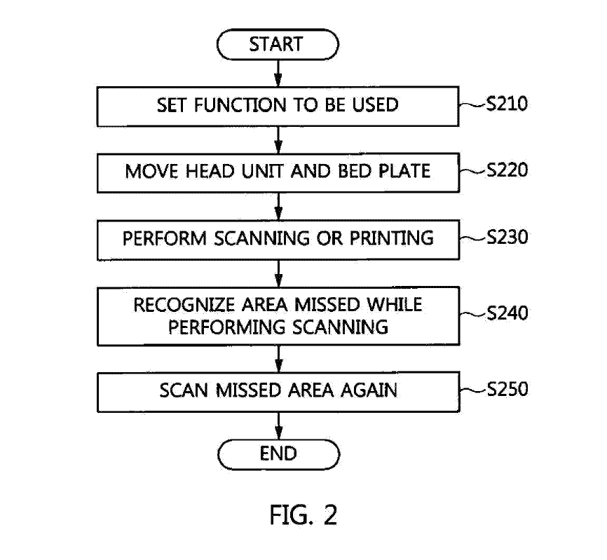

Hereinafter, a method for operating a 3D multifunctional device according to an embodiment of the present invention will be described in detail with reference to FIGS. 2 to 6.

FIG. 2 is a flowchart illustrating a method for operating a 3D multifunctional device according to an embodiment of the present invention.

First, a function to be used is set in the 3D multifunctional device 100 at step S210.

The 3D multifunctional device 100 according to an embodiment of the present invention may perform a 3D printing function and a 3D scanning function. The 3D multifunctional device 100 sets the function by receiving the kind of function from the user, or automatically sets the function by detecting that an object 200 to be scanned is located on the bed plate 140 of the 3D multifunctional device 100.

Also, if the printing unit 110 or the scanning unit 120 of the 3D multifunctional device 100 is detachable from the head unit 130, the 3D multifunctional device 100 may determine whether the printing unit 110 or the scanning unit corresponding to the set function is mounted thereon.

Next, the 3D multifunctional device 100 moves the head unit and the bed plate at step S220.

The 3D multifunctional device 100 moves the head unit 130 in the X-axis and Y-axis directions to correspond to the set function, or moves the bed plate 140 in the Z-axis direction.

For example, when a 3D printing function is set to be used, the 3D multifunctional device 100 moves the head unit 130 in the X-axis direction or the Y-axis direction according to the 3D printing process to enable a nozzle to perform 3D printing. Also, when the printing unit 110 completes the deposition of one layer by spraying material, the 3D multifunctional device 100 may move the bed plate 140 in the Z-axis direction.

Also, when a 3D scanning function is set to be used, the 3D multifunctional device 100 may move the head unit 130 and rotate the bed plate 140, which is in the form of a turntable. Here, in the case of the 3D multifunctional device 100 according to an embodiment of the present invention, because the scanning unit 120 is mounted on the head unit 130 and moves to correspond to the movement of the head unit 130, areas missed during scanning may be minimized when performing 3D scanning of the object 200 to be scanned.

Subsequently, at step S230, the 3D multifunctional device 100 performs 3D scanning or 3D printing to correspond to the function set at step S210.

If the 3D multifunctional device 100 is set to perform a 31) printing function, the extruder pushes material into the nozzle using a motor and applies heat thereto to melt the material, Also, the nozzle, arranged in front of the extruder, outputs the melted material in the desired size. Here, the nozzle outputs the material while moving to correspond to the movement of the head unit 130.

Meanwhile, when the 3D multifunctional device 100 is set to perform a 3D scanning function, the scanning unit 120 radiates light to the object 200 to be scanned, which is located on the bed plate 140, and scans the object 200 by capturing an image of the light reflected from the object 200 to be scanned.

If the 3D multifunctional device 100 performs 3D scanning at step S230, the 3D multifunctional device 100 detects missed areas during scanning at step S240.

The 3D multifunctional device 100 determines whether areas were missed during scanning while performing 3D scanning of the object 200 to be scanned. The areas may be missed when light is not emitted to every part of the object 200 while the object 200 is rotated on the bed plate 140, or when the reflected light cannot be captured by the camera because the radiated light is blocked by the structure of the object to be scanned 200.

Finally, if it is determined that an area was missed during scanning, the 3D multifunctional device 100 scans the missed area again at step S250.

The 3D multifunctional device 100 may generate a complete 3D scan data of the object 200 to be scanned by scanning the missed area again. In this case, in order to again scan only the part of the object 200, in which the area was missed, the 3D multifunctional device 100 radiates the light to the corresponding part. Then, in order to capture an image of the light reflected from the object 200 to be scanned, the 3D multifunctional device 100 may move the head unit 130 to the location corresponding to the missed area, adjust the height of the bed plate 140, or control the rotation of the bed plate 140.

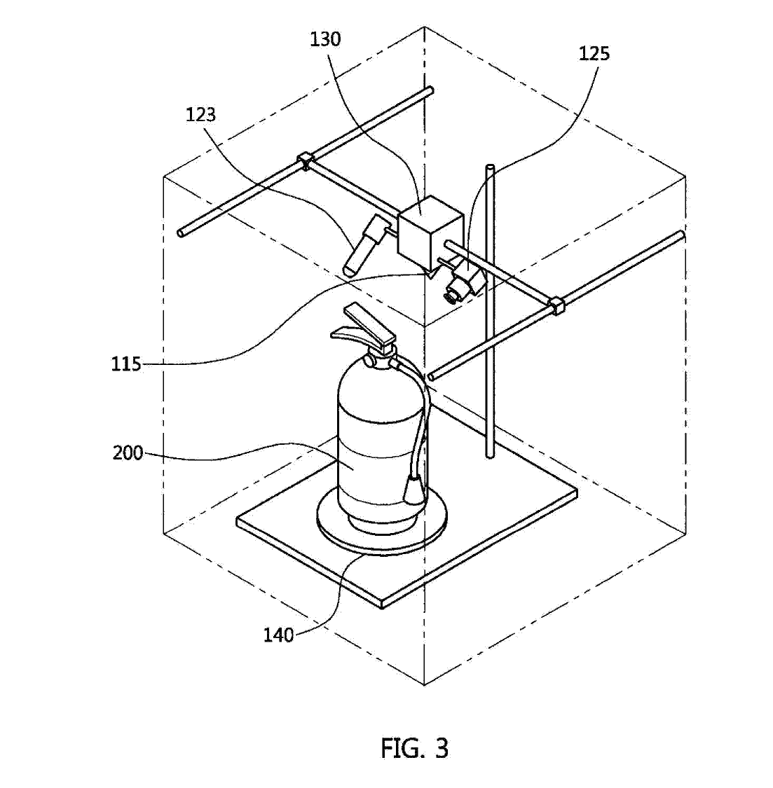

Hereinafter, the structure of the 3D multifunctional device 100 according to an embodiment of the present invention will be described in detail with reference to FIGS. 3 to 6.

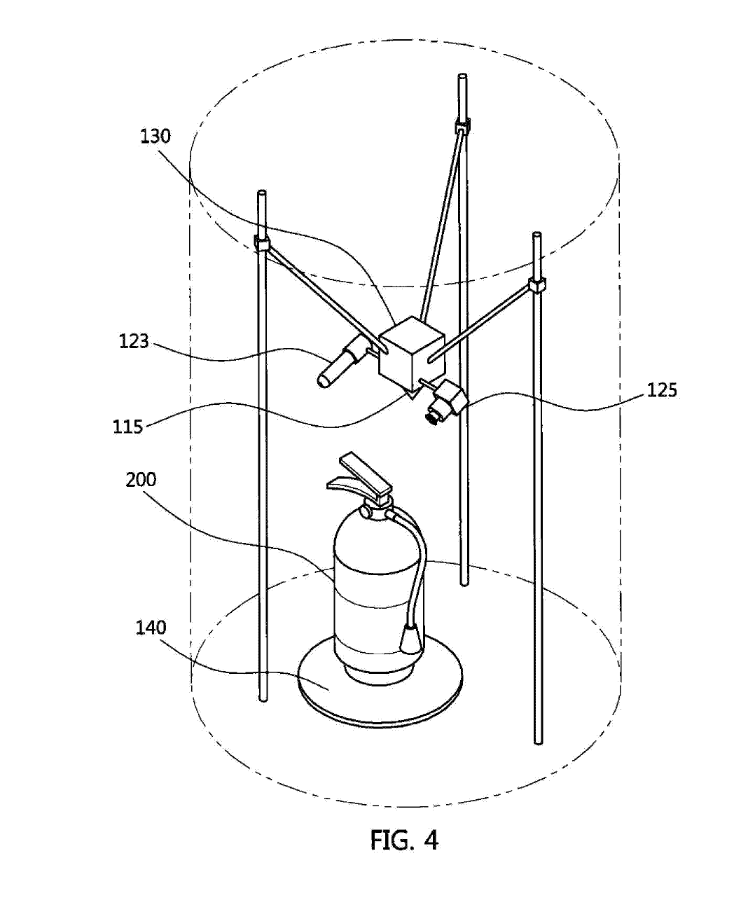

FIG. 3 is a view illustrating the structure of a 3D multifunctional device according to a first embodiment of the present invention, and FIG. 4 is a view illustrating the structure of a 3D multifunctional device according to a second embodiment of the present invention.

FIG. 3 shows the case in which the head unit 130 may move in the X-axis and Y-axis directions, and FIG. 4 shows the case in which the head unit 130 may move not only in the X-axis and Y-axis directions but also in the Z-axis direction.

As illustrated in FIGS. 3 and 4, a nozzle 115 may be located below the head unit 130. Also, with the nozzle as the center, a light radiation module 123 and a camera 125 may respectively be located on the left and right sides of the head unit 130. The bed plate 140, on which the object to be scanned 200 is located or material is deposited during 3D printing, may be in the form of a turntable, and may rotate clockwise or counterclockwise.

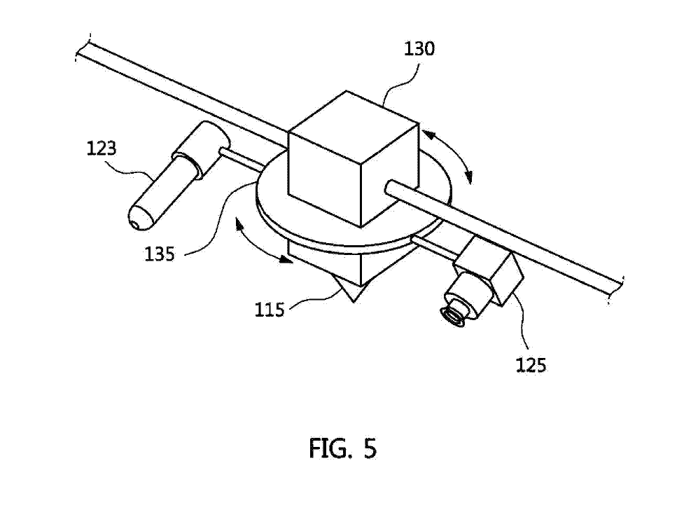

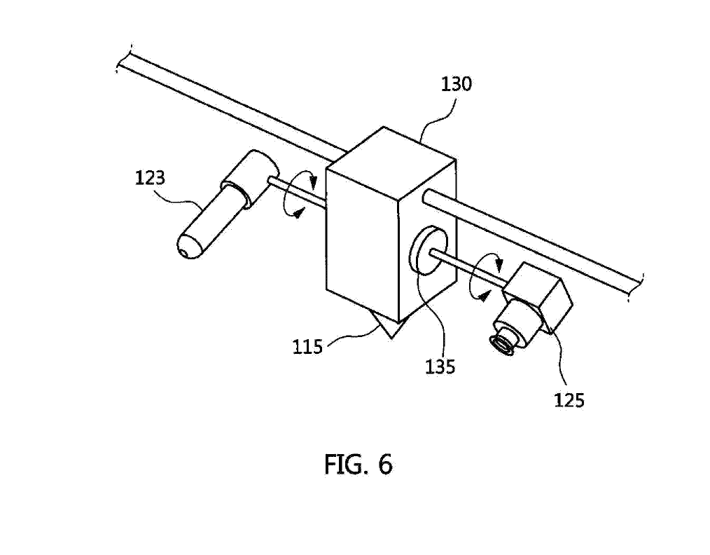

FIG. 5 is a view illustrating the structure of a head unit according to a first embodiment of the present invention, and FIG. 6 is a view illustrating the structure of a head unit according to a second embodiment of the present invention.

As illustrated in FIGS. 5 and 6, the head unit 130 may have a rotation module 135 for rotating a light radiation module 123 and a camera 125. Accordingly, the head unit 130 may rotate the light radiation module 123 and the camera 125 with respect to any one axis using the rotation module. In this case, the rotation module 135 may be installed in the head unit 130 in order to prevent the nozzle 115 from being affected by the rotation of the rotation module 135.

According to the present invention, there is provided a 3D multifunctional device that is capable of both 3D printing and 3D scanning without requiring that an additional module be installed in a 3D printer, or using the minimum number of modules.

Also, the present invention may minimize areas that are missed when performing 3D scanning.

Also, because the present invention implements a scanning unit for 3D scanning as a detachable unit, the scanning unit can be mounted on a 3D multifunctional device when a user needs it.

As described above, the 3D multifunctional device and method thereof are not limitedly applied to the configurations and operations of the above-described embodiments, but all or some of the embodiments may be selectively combined and configured so that the embodiments may be modified in various ways.

What is claimed is:

1. A 3D multifunctional device comprising:
a printing unit that includes a nozzle for ejecting a material for 3D printing of an object;
a scanning unit that includes a light radiation module for radiating light to an object to be scanned and a camera for capturing an image of the object to be scanned;
a head unit for moving the printing unit and the scanning unit in X-axis and Y-axis directions;
a bed plate on which the object to be scanned is located or the material ejected from the nozzle is deposited, the bed plate moving in a Z-axis direction; and
a control unit for setting a function to be used by selecting either a 3D scanning function or a 3D printing function, for controlling the scanning unit or the printing unit to correspond to the set function, and for controlling movements of the head unit and the bed plate,
wherein the printing unit and the scanning unit are connected to each other through the head unit.

2. The 3D multifunctional device of claim 1, wherein the printing unit or the scanning unit is detachable from the head unit.

3. The 3D multifunctional device of claim 1, wherein the head unit comprises the light radiation module and the camera, located on respective opposite sides of the nozzle.

4. The 3D multifunctional device of claim 1, wherein the light radiation module radiates linear light to the object to be scanned in a Y-axis direction.

5. The 3D multifunctional device of claim 1, wherein the light radiation module radiates any one of laser light, modulated light, and structured light.

6. The 3D multifunctional device of claim 1, wherein the bed plate has a form of a rotatable turntable.

7. The 3D multifunctional device of claim 6, wherein if the 3D scanning function is set to operate, the control unit rotates the bed plate and moves the head unit to make the light radiation module and the camera scan the object to be scanned in 3D.

8. The 3D multifunctional device of claim 3, wherein the head unit comprises a rotation module that is rotatable with respect to any one axis,
the rotation module rotating at least one of the nozzle, the light radiation module, and the camera.

9. The 3D multifunctional device of claim 1, wherein the control unit detects an area missed during scanning of the object to be scanned and makes the scanning unit scan the missed area again by moving the head unit and the bed plate when the missed area occurs.

10. A method for operating a 3D multifunctional device, comprising:
setting a function to be used by selecting either a 3D scanning function or a 3D printing function;
moving a head unit in X-axis and Y-axis directions or moving a bed plate in a Z-axis direction, to correspond to the set function;
if the 3D scanning function is set, radiating light to an object to be scanned, which is located on the bed plate, and capturing an image of the object to be scanned, and
if the 3D printing function is set, ejecting a material for 3D printing of an object on the bed plate,
wherein the head unit comprises a light radiation module for radiating the light, a camera for capturing the image of the object to be scanned, and a nozzle for ejecting the material.

11. The method of claim 10, wherein at least one of the light radiation module, the camera, and the nozzle is detachable from the head unit.

12. The method of claim 10, wherein the head unit comprises the light radiation module and the camera, located on respective opposite sides of the nozzle.

13. The method of claim 10, wherein the light radiation module radiates linear light to the object to be scanned in a Y-axis direction.

14. The method of claim 10, wherein the light radiation module radiates any one of laser light, modulated light, and structured light.

15. The method of claim 10, wherein the bed plate has a form of a rotatable turntable.

16. The method of claim 15, further comprising,
when the 3D scanning function is set to operate,
rotating the bed plate;
moving the head unit; and
scanning, by the light radiation module and the camera, the object to be scanned in 3D.

17. The method of claim 10, wherein the head unit further comprises a rotation module that is rotatable with respect to any one axis,
the rotation module rotating at least one of the nozzle, the light radiation module, and the camera.

18. The method of claim 10, further comprising:
detecting an area missed during scanning of the object to be scanned; and
scanning, by the scanning unit, the missed area again by moving the head unit and the bed plate when the missed area occurs.
